(19) United States
(12) Patent Application Publication
(10) Pub. No.: US 2008/0060827 A1
(43) Pub. Date: Mar. 13, 2008

(54) Power Tool With Dust Seal

(76) Inventor: Torbjorn Gunnar Walheim, Stockholm (SE)

Correspondence Address: FRISHAUF, HOLTZ, GOODMAN & CHICK, PC, 220 Fifth Avenue, 16TH Floor, NEW YORK, NY, 10001-7708, US

(21) Appl. No.: 11/571,405

(22) PCT Filed: Jun. 29, 2005
(86) PCT No.: PCT/SE05/01022

§ 371 Date: Dec. 28, 2006

(30) Foreign Application Priority Data
Jun. 30, 2004 (SE) 0401674-7

(51) Int. Cl. B23Q 11/00

(52) U.S. Cl. 173/217

(57) ABSTRACT

A power tool having a housing (10,11), a rotation motor and an output shaft (12;112) journalled in the housing (10,11) and adapted to carry a working implement, wherein the housing (10,11) has a neck portion (19) with an annular seal surface (22), and a seal structure (23;123) on the output shaft (12;112) has a clearance surface (24; 124) facing the annular seal surface (22) of the housing (10,11) and being arranged with a narrow gap (25;125) left between the clearance surface (24;124) and the annular seal surface (22) on the housing (10,11) to form a contact free dust barrier intended to prevent foreign particles from entering the housing (10,119), and an air flow path is provided in the housing (10;119) to supply air at the inner periphery of the clearance surface (24;124) thereby generating by centrifugal action an air flow out through the narrow gap (25;125) at rotation of the output shaft (12).

The invention relates to a power tool with a housing and a rotation motor driving an output shaft on which a working implement is attachable, wherein the housing is formed with a front end neck portion co-axially surrounding the output shaft and supporting a bearing for the output shaft.

A problem concerned with this kind of power tools, particularly of the material removing type of tool like grinders and drilling tools, is the difficulty to prevent dust and debris produced during the working process from finding its way into the housing and cause damage to the output shaft bearings etc. thereby reducing the service life of the tool. For instance, the dust and debris produced at grinding or sanding fibre glass re-inforced plastics is not only difficult to stop from entering the tool housing it is very harmful to the shaft bearing when once entered the housing.

This problem has resulted in many previous attempts to improve the seal around the output shaft, for instance by providing different types seal rings of resilient materials like rubber etc. However, these attempts have turned out to be insufficient, because in dusty environments the seal rings have been worn down quite quickly and, thereby, lost most of their sealing properties. The results have always been that dust and debris from the working process still has found its way into the tool housing and affected the service life of the shaft bearings etc. Another problem with resilient seal rings which are maintained in a continuous contact with the rotation shaft is the friction related heat generation. This heat is not only detrimental to the seal ring itself but causes a hot front part of the housing and, thereby, a burning risk to the operator.

It is the main object of the invention to provide a power tool with a motor driven output shaft, wherein a barrier forming means is provided around the output shaft to create a friction free seal means preventing dust and debris from penetrating into the housing and cause damage to the shaft bearing etc.

Further objects and advantages of the invention will appear from the following specification and claims.

A preferred embodiment of the invention is below described in detail with reference to the accompanying drawing.

In the drawing

FIG. 1 shows a longitudinal section through the front part of a power tool according to one embodiment of the invention.

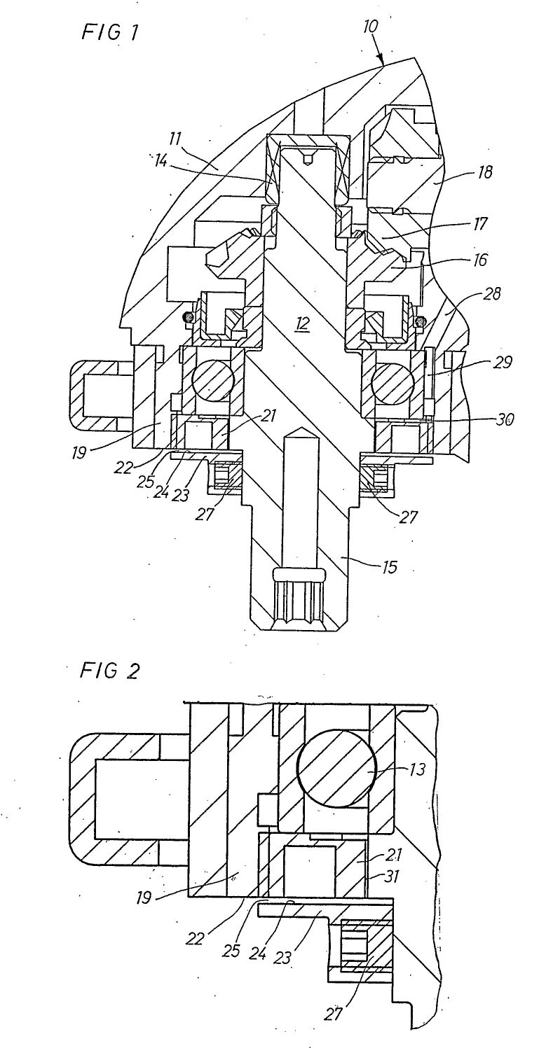

FIG. 2 shows, on a larger scale, a fragmentary section of the power tool in FIG. 1.

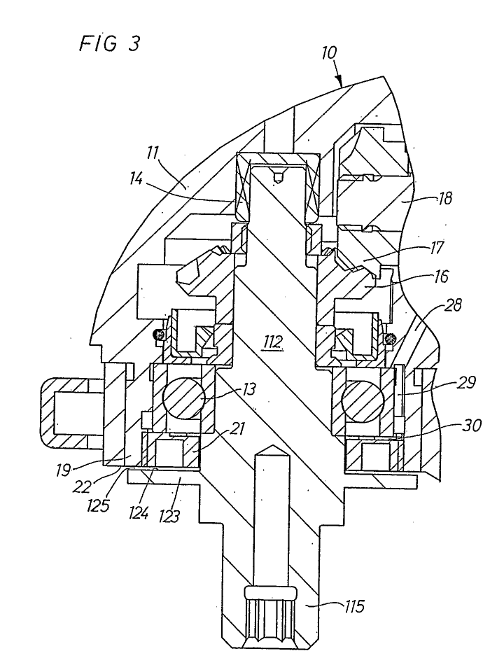

FIG. 3 shows a longitudinal section similar to FIG. 1 but illustrating a power tool according to an alternative embodiment of the invention.

In FIG. 1 there is illustrated the front end of an angle grinder having a housing 10 with an angle head 11 in which an output shaft 12 is rotatively journalled in a forward ball bearing 13 and a rear needle bearing 14. The output shaft 12 is formed with a mounting means 15 for attachment of a working implement like a non-illustrated grinding wheel. The output shaft 12 also carries a bevelled gear 16 to be driven by a pinion 17 connected to a motor spindle 18. The angle head 11 is formed with a neck portion 19 in which the ball bearing 13 is supported. A ring screw 21 is threaded into the neck portion 19 to secure the ball bearing 13 to the housing 10. This ring screw 21 forms an annular end surface 22 of the angle head 11.

On the output shaft 12 there is provided a seal structure in the form of a ring element 23. This ring element 23 is formed with a flat clearance surface 24 facing the annular end surface 22 and being disposed close to the latter leaving just a narrow air gap or clearance 25 therebetween. See FIG. 2. The ring element 23 is secured to the output shaft 12 by a couple of lock screws 27, which means that the ring element 23 may be fitted as required, also to grinders already in operation at a working site.

The gap 25 is narrow enough, suitably 0.01-0.05 mm, to form an effective barrier against dust penetration into the angle head 11, thereby protecting the bearing 13 against detrimental particles.

In order to enhance the dust barrier forming properties of the gap 25 there is provided an air flow path extending through the housing 10 and ending in the gap 25. Air is drawn through this air flow path and through the gap 25 by a pumping action accomplished by the clearance surface 24 during operation of the tool.

To form that air flow path the housing 10 is provided with an air passage 28 which includes axial grooves 29 provided in the housing 10 outside the ball bearing 13, radial grooves 30 in the ring screw 21, and an annular clearance 31 between the ring screw 21 and the output shaft 12.

In operation of the tool the output shaft 12 is rotated at high speed, and due to centrifugal action exerted on the air in the clearance 25 by the clearance surface 24 a certain air flow is created in the passage 28 and out through the clearance 25. This means that particles like dust and debris emanating from the grinding process will be prevented from entering the clearance 25 and to get inside the ring screw 21 and reach the ball bearing 13. Since this dust barrier is formed by the clearance 25 and accordingly runs completely friction free there will be no heating developed and no mechanical wear.

In the embodiment illustrated in FIG. 2 a seal structure in the form of an annular flange 123 formed integrally with the output shaft 112 as a one-piece element, also including a working implement mounting means 115. The flange 123 is formed with a clearance surface 124 which is located so as to form a narrow gap 125 with the annular end surface 22 of the housing neck portion 19, including the ring screw 21.

The operation order of this integrated flange embodiment is the same as described for the above separate ring element 23 embodiment.

It is to be observed that the embodiments of the invention are not limited to the above described examples but can be freely varied within the scope of the claims. For instance, the separate ring element concept also includes ring elements secured to the output shaft 12 via a press fit or via a thread.

1. A power tool comprising a housing, a rotation motor, and an output shaft connected to the motor and having means for attaching a working implement, wherein the housing includes a neck portion co-axially surrounding the output shaft, wherein:
said neck portion comprises an annular end surface disposed at a right angle relative to the output shaft,
a rotating seal structure is provided on the output shaft, said seal structure having an axially facing clearance surface disposed opposite said annular end surface, and
an air gap arranged between said annular end surface and said clearance surface , said air gap being narrow enough to form a contact free dust stopping barrier around the output shaft.

2. The power tool according to claim 1, wherein said seal structure comprises a disc shaped element secured to the output shaft.

3. The power tool according to claim 2, wherein said disc shaped element (23) is secured to the output shaft via lock screws.

4. The power tool according to claim 1, wherein said seal structure comprises a flange formed integrally with the output shaft.

5. The power tool according to claim 1, wherein an air passage is provided in the housing and extends from inside the housing to said annular end surface of said neck portion to supply air at the neck portion end surface, and said clearance surface acts as a pump element to force air out through the gap arranged between said annular end surface and said clearance surface, thereby preventing particles from entering through the gap.
